(19) United States
(12) Patent Application Publication
(10) Pub. No.: US 2024/0086719 A1
(43) Pub. Date: Mar. 14, 2024

(54) SPARSE ENCODING AND DECODING AT MIXTURE-OF-EXPERTS LAYER

(71) Applicant: Microsoft Technology Licensing, LLC, Redmond, WA (US)

(72) Inventors: Yifan XIONG, Beijing (CN); Changho HWANG, Cheongju-si (KR); Wei CUI, Beijing (CN); Ziyue YANG, Beijing (CN); Ze LIU, Beijing (CN); Han HU, Beijing (CN); Zilong WANG, Beijing (CN); Rafael Omar SALAS, Tega Cay, SC (US); Jithin JOSE, Austin, TX (US); Prabhat RAM, Los Altos, CA (US); Ho-Yuen CHAU, Bellevue, WA (US); Peng CHENG, Beijing (CN); Fan YANG, Beijing (CN); Mao YANG, Beijing (CN); Yongqiang XIONG, Beijing (CN)

(73) Assignee: Microsoft Technology Licensing, LLC, Redmond, WA (US)

(21) Appl. No.: 18/318,436

(22) Filed: May 16, 2023

Related U.S. Application Data
(60) Provisional application No. 63/375,368, filed on Sep. 12, 2022.

(51) Int. Cl. G06N 3/098; G06N 3/0455; G06N 3/048

(52) U.S. Cl. CPC G06N 3/098; G06N 3/0455; G06N 3/048

(57) ABSTRACT

A computing system including a plurality of processing devices configured to execute a Mixture-of-Experts (MoE) layer. The processing devices are configured to execute the MoE layer at least in part by receiving an input tensor including input tokens. Executing the MoE layer further includes computing a gating function output vector based on the input tensor and computing a sparse encoding of the input tensor and the gating function output vector. The sparse encoding indicates one or more destination expert sub-models. Executing the MoE layer further includes dispatching the input tensor for processing at the one or more destination expert sub-models, and further includes computing an expert output tensor. Executing the MoE layer further includes computing an MoE layer output at least in part by computing a sparse decoding of the expert output tensor. Executing the MoE layer further includes conveying the MoE layer output to an additional computing process.

### CROSS REFERENCE TO RELATED APPLICATIONS

This application claims priority to U.S. Provisional Patent Application Ser. No. 63/375,368, filed Sep. 12, 2022, the entirety of which is hereby incorporated herein by reference for all purposes.

### BACKGROUND

From the recent fast growth of machine learning (ML) techniques driven by deep neural networks (DNNs), utilizing more DNN model parameters has been found to be one of the most straightforward approaches to improving the performance of ML algorithms. However, DNN model capacity is often limited by computing and energy costs. Such costs may be incurred as a result of the dense architecture of DNNs, in which the computing cost typically scales linearly as a function of the number of parameters.

To address these costs, DNNs may be built using a Mixture-of-Experts (MoE) approach. MoE introduces a sparse architecture by employing multiple parallel sub-models called experts, where each input is forwarded to a subset of the experts based on an intelligent gating function. Unlike dense layers, MoE may scale the model capacity up (thereby increasing model accuracy) without incurring large additional costs, since MoE may enroll more model parameters while leaving some of the model parameters unused in each forward pass.

### SUMMARY

According to one aspect of the present disclosure, a computing system is provided, including a plurality of processing devices configured to execute a Mixture-of-Experts (MoE) layer included in an MoE model. The plurality of processing devices are configured to execute the MoE layer at least in part by receiving an input tensor including a plurality of input tokens. Executing the MoE layer further includes computing a gating function output vector based at least in part on the input tensor. Executing the MoE layer further includes computing a sparse encoding of the input tensor and the gating function output vector. The sparse encoding indicates one or more destination expert sub-models included among a plurality of expert sub-models in the MoE layer. Executing the MoE layer further includes dispatching the input tensor for processing at the one or more destination expert sub-models. Executing the MoE layer further includes computing an expert output tensor at the one or more destination expert sub-models. Executing the MoE layer further includes computing an MoE layer output at least in part by computing a sparse decoding of the expert output tensor. Executing the MoE layer further includes conveying the MoE layer output to an additional computing process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically depicts a computing system including a plurality of processing devices at which a Mixture-of-Experts (MoE) model is configured to be executed, according to one example embodiment.

FIG. 2 schematically shows an MoE layer of the MoE model in additional detail, according to the example of FIG. 1.

FIG. 3 schematically shows the computing system when a gating function is executed, according to the example of FIG. 2.

FIG. 4 schematically shows the computing system when a sparse encoding is generated, according to the example of FIG. 3.

FIG. 5 schematically shows the computing system when the sparse decoding is processed at a destination expert sub-model and an MoE layer output is generated, according to the example of FIG. 2.

FIG. 6A schematically shows an example of a sparse encode operator, according to the example of FIG. 4.

FIG. 6B schematically shows an example of a sparse decode operator, according to the example of FIG. 5.

FIG. 7 schematically shows computation of a location vector, according to the example of FIGS. 6A-6B.

FIG. 8A schematically shows the computing system when the sparse decode operator is executed during a backward pass performed in a training phase, according to the example of FIG. 6B.

FIG. 8B schematically shows the computing system when the sparse encode operator is executed during the backward pass, according to the example of FIG. 6A.

FIG. 9 schematically shows an additional transformation that may be performed when the sparse encoding is generated, according to the example of FIG. 2.

FIG. 10A shows a flowchart of a method for use with a computing system to execute an MoE layer included in an MoE model, according to the example of FIG. 1.

FIG. 10B shows additional steps of the method of FIG. 10A that may be performed when the sparse encoding is computed.

FIG. 10C shows additional steps of the method of FIG. 10A that may be performed when the sparse encoding and the sparse decoding are computed.

FIG. 10D shows additional steps of the method of FIG. 10A that may be performed when training the MoE layer.

FIG. 11 shows a schematic view of an example computing environment in which the computing system of FIG. 1 may be instantiated.

### DETAILED DESCRIPTION

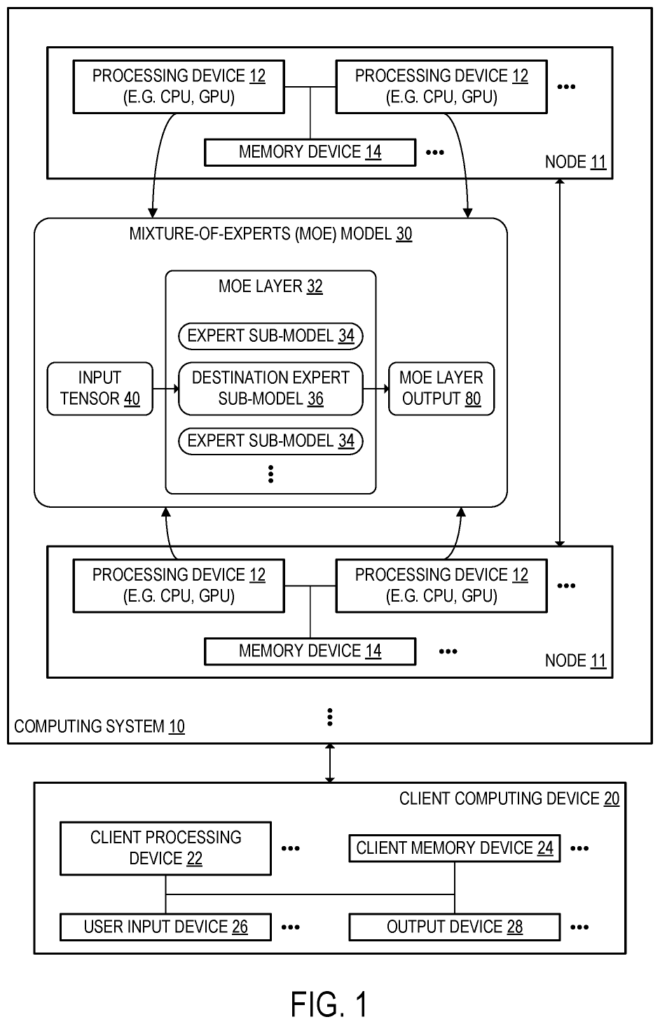

FIG. 1 schematically depicts a computing system 10 including a plurality of processing devices 12. As discussed in further detail below, the plurality of processing devices 12 are configured to execute an MoE layer 32 included in an MoE model 30. The plurality of processing devices 12 may, for example, include one or more central processing units (CPUs), one or more graphics processing units (GPUs), and/or one or more other hardware accelerators. In the example of FIG. 1, execution of the MoE model 30 is parallelized across the plurality of processing devices 12.

The plurality of processing devices 12 may, as shown in FIG. 1, be included in a plurality of nodes 11, which may be separate physical computing devices included in the computing system 10. In such examples, each of the nodes 11 may include two or more of the plurality of processing devices 12. Each of the nodes 11 further includes one or more memory devices 14 communicatively coupled to the processing devices 12. In addition, the plurality of nodes 11 included in the computing system 10 are communicatively coupled such that input and output data are transmitted between the processing devices 12 included in separate nodes 11.

The nodes 11 may be located in a data center and may function as server computing devices. The computing system 10 may, in such examples, be configured to communicate with a client computing device 20 over a network. The client computing device 20, as shown in FIG. 1, includes one or more client processing devices 22 and one or more client memory devices 24. In addition, the client computing device 20 includes one or more user input devices 26 and one or more output devices 28 via which a user may interact with the client processing device 22 and client memory device 24. A graphical user interface (GUI) may be provided at the client computing device 20 using the one or more user input devices 26 and the one or more output devices 28. Thus, the user of the client computing device 20 may specify inputs to, and receive outputs from, the MoE model 30 executed at the computing system 10.

The MoE model 30 shown in FIG. 1 includes one or more MoE layers 32. In some examples, the MoE model 30 may further include one or more other types of layers, such as one or more linear feed-forward layers. The other layers may be interspersed with the MoE layers 32 in the MoE model. The MoE layer 32 is configured to receive an input tensor 40 and to generate an MoE layer output 80 based at least in part on the input tensor 40. The input tensor 40 may be received from a prior layer of the MoE model 30 or may be an initial input to the MoE model 30. The MoE layer output 80 may be an output tensor that is transmitted to a subsequent layer of the MoE model 30 or may alternatively be a final output of the MoE model 30.

As discussed above, when an MoE model 30 is executed, the inputs to the MoE model 30 are processed in a sparse manner such that each input is received at some subset of the plurality of expert sub-models 34 included in each MoE layer 32. The one or more expert sub-models 34 included in this subset are destination expert sub-models 36. The sparse selection of one or more destination expert sub-models 36 when processing the input tensor 40 typically leads the plurality of processing devices 12 to generate sparse tensors that include large numbers of elements that are equal to zero. In previously existing MoE models, large numbers of operations are typically performed on elements of the sparse tensors that are equal to zero, thereby resulting in wasted processing time at the plurality of processing devices 12. To decrease the number of operations performed on tensor elements that are equal to zero, and to accordingly increase the efficiency of training and inferencing at the MoE model 30, the techniques discussed below are provided.

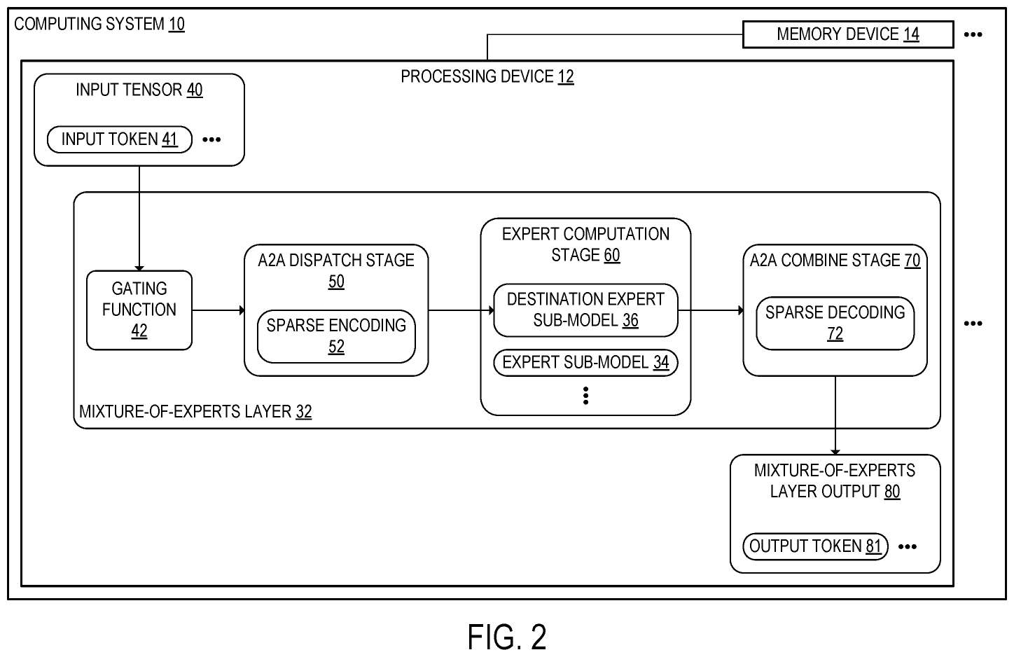

FIG. 2 schematically shows the MoE layer 32 of the MoE model 30 in additional detail. At the MoE layer 32, the plurality of processing devices 12 are configured to receive an input tensor 40 including a plurality of input tokens 41. The MoE layer 32 as shown in FIG. 2 includes a gating function 42 that is configured to receive the input tensor 40 and determine the one or more destination expert sub-models 36 at which the input tensor 40 is configured to be processed. In some examples, the input tokens 41 may be a plurality of different destination expert sub-models 36, with those destination expert sub-models 36 receiving respective non-overlapping subsets of the input tokens 41 included in the input tensor 40.

The MoE layer 32 further includes an all-to-all (A2A) dispatch stage 50. At the A2A dispatch stage 50, the plurality of processing devices 12 are further configured to share data among each other using an A2A dispatch operation. Accordingly, the plurality of processing devices 12 may be configured to process the shared data in parallel. The data shared at the A2A dispatch stage 50 may be a sparse encoding 52, the computation of which is discussed in further detail below.

Subsequently to the A2A dispatch stage 50, the plurality of processing devices 12 are further configured to execute the one or more destination expert sub-models 36 at an expert computation stage 60. The plurality of processing devices 12 are further configured to combine the outputs of the destination expert sub-models 36 computed at the respective processing devices 12 during an A2A combine stage 70. During the A2A combine stage 70, as shown in the example of FIG. 2, the plurality of processing devices 12 are further configured to compute a sparse decoding 72 of the data combined during the A2A combine stage 70.

The plurality of processing devices 12 are further configured to compute the MoE layer output 80 of the MoE layer 32 based at least in part on the sparse decoding 72. The plurality of processing devices 12 may be configured to assemble the MoE layer output 80 from a plurality of sub-tensors computed in parallel at the plurality of processing devices 12. In some examples, the MoE layer output 80 may include a plurality of output tokens 81.

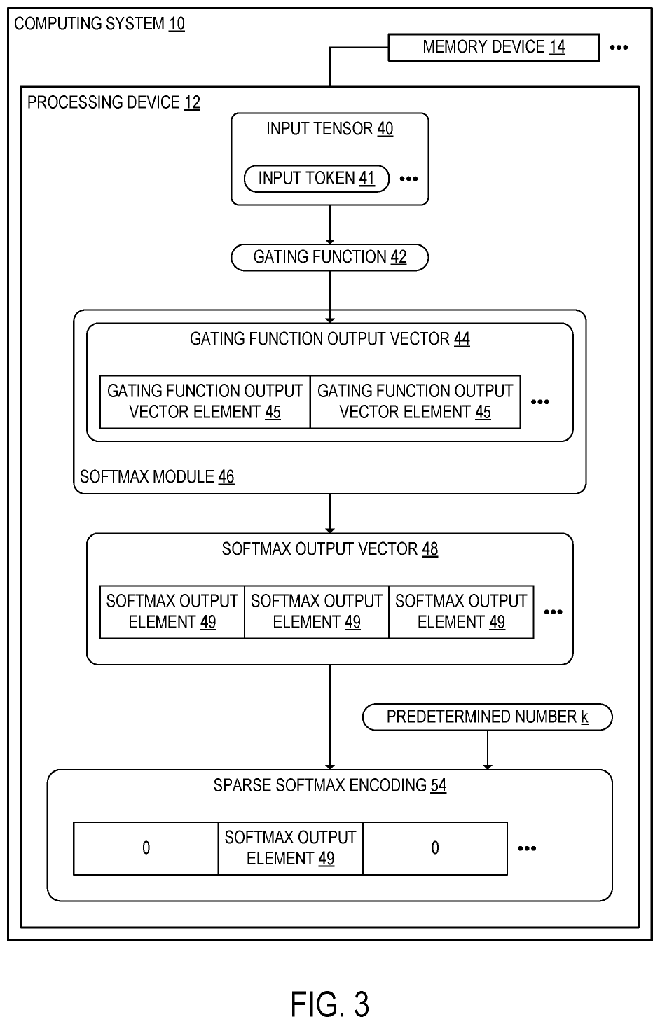

The plurality of processing devices 12 are shown in additional detail in the example of FIG. 3 when the gating function 42 is executed. At the gating function 42, the plurality of processing devices are configured to compute a gating function output vector 44 based at least in part on the input tensor 40. The gating function output vector 44 specifies the one or more destination expert sub-models 36 at which the plurality of processing devices 12 are configured to process the input tokens 41 included in the input tensor 40. The gating function 42 includes a plurality of learnable parameters that are trained during training of the MoE model 30. For example, the gating function 42 may include a linear layer. The gating function output vector 44 includes a plurality of gating function output vector elements 45, which may be logits respectively associated with each of the expert sub-models 34. The probability of processing an input token 41 at a particular expert sub-model 34 may scale with the value of the gating function output vector element 45 associated with that expert sub-model 34.

The plurality of processing devices 12 are further configured to execute a SoftMax module 46 at which the plurality of processing devices 12 compute a SoftMax output vector 48 based at least in part on the gating function output vector 44. The SoftMax output vector 48 includes a plurality of SoftMax output elements 49. At the SoftMax module 46, the plurality of processing devices 12 are configured to compute the SoftMax of each of the gating function output vector elements 45 to thereby generate the SoftMax output elements 49.

The plurality of processing devices 12 are each further configured to compute a sparse SoftMax encoding 54 of the SoftMax output vector 48. Since most of the outputs of the SoftMax function are typically close to zero, the sparse SoftMax encoding 54 may be computed by setting a subset of the SoftMax output elements 49 to zero. The plurality of processing devices 12 may be configured to compute the sparse SoftMax encoding 54 at least in part by setting each SoftMax output element 49 of the SoftMax output vector 48, other than a predetermined number k of one or more selected SoftMax output elements 49, equal to zero. The predetermined number k of the SoftMax output elements 49 may be the top-k largest SoftMax output elements 49 among the plurality of SoftMax output elements 49.

The predetermined number k may be specified by the user in some examples. For example, an application-programming interface associated with the MoE layer 32 may be used to set the predetermined number k according to user input. In some examples, the value of k may be dynamically modified over the course of processing a plurality of input tensors 40. For example, during training of the MoE layer 32, k may be increased at later iterations in order to account for increases in the workloads of forward passes over the course of the training run.

By setting some elements of the SoftMax output vector 48 equal to zero, the plurality of processing devices 12 may sparsify the SoftMax output vector 48, which may allow the processing devices 12 to subsequently process the sparse SoftMax encoding 54 using fewer computational resources. Since operations following the computation of the sparse SoftMax encoding 54 may also have sparse outputs, the efficiency of multiple subsequent operations may be increased due to the sparsification of the SoftMax output vector 48.

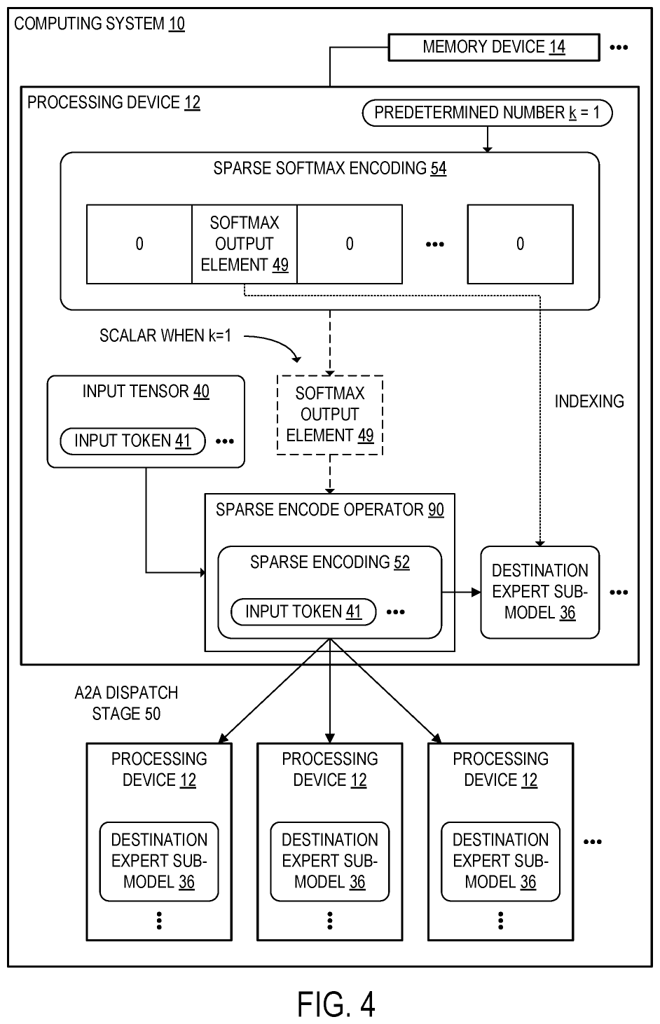

FIG. 4 schematically shows the computing system 10 when the sparse SoftMax encoding 54 is further processed to generate the sparse encoding 52. The sparse encoding 52 may indicate one or more destination expert sub-models 36 included among the plurality of expert sub-models 34 in the MoE layer 32. The positions of the one or more nonzero SoftMax output elements 49 within the sparse SoftMax encoding 54 may correspond to indices of the one or more destination expert sub-models 36. In the example of FIG. 4, the plurality of processing devices 12 are further configured to assign the input tokens 41 to the one or more destination expert sub-models 36 as specified by the selected SoftMax output elements 49 that are not set to zero. The predetermined number k, in such examples, is equal to a number of the one or more destination expert sub-models 36 to which the input tokens 41 included in the input tensor 40 are assigned.

The plurality of processing devices 12 may be further configured to perform an additional sparsifying transform on the sparse SoftMax encoding 54 in examples in which the predetermined number k is equal to one. In such examples, subsequently to setting each of the plurality of SoftMax output elements 49 other than one SoftMax output element 49 to zero, the plurality of processing devices 12 may be further configured to compress the sparse SoftMax encoding 54 into a scalar equal to the nonzero SoftMax output element 49. Accordingly, the sparse SoftMax encoding 54 may be further sparsified by deleting the zero elements.

The plurality of processing devices 12 are further configured to compute a sparse encoding 52 of the input tensor 40 and the gating function output vector 44 using the sparse SoftMax encoding 54. The sparse encoding 52 is computed by executing a sparse encode operator 90 that receives the input tensor 40 and the sparse SoftMax encoding 54 as input. The sparse encoding 52 may indicate the one or more destination expert sub-models 36 and may further include the plurality of input tokens 41. In some examples, the sparse encoding may have dimensions (E, OC, M), where E is the total number of expert sub-models 34, ΔC is a local number of input tokens 41 processed at each of the processing devices 12 within a local capacity limit, and M is a channel size of each of the expert sub-models 34.

The plurality of processing devices 12 are further configured to dispatch the input tensor 40 for processing at the one or more destination expert sub-models 36. As depicted in the example of FIG. 2, the plurality of processing devices are configured to dispatch the sparse encoding 52 of the input tensor 40 and the gating function output vector 44 across the plurality of processing devices 12 in an A2A dispatch operation. In the A2A dispatch operation, respective copies of the sparse encoding 52 are transmitted to each of the processing devices 12.

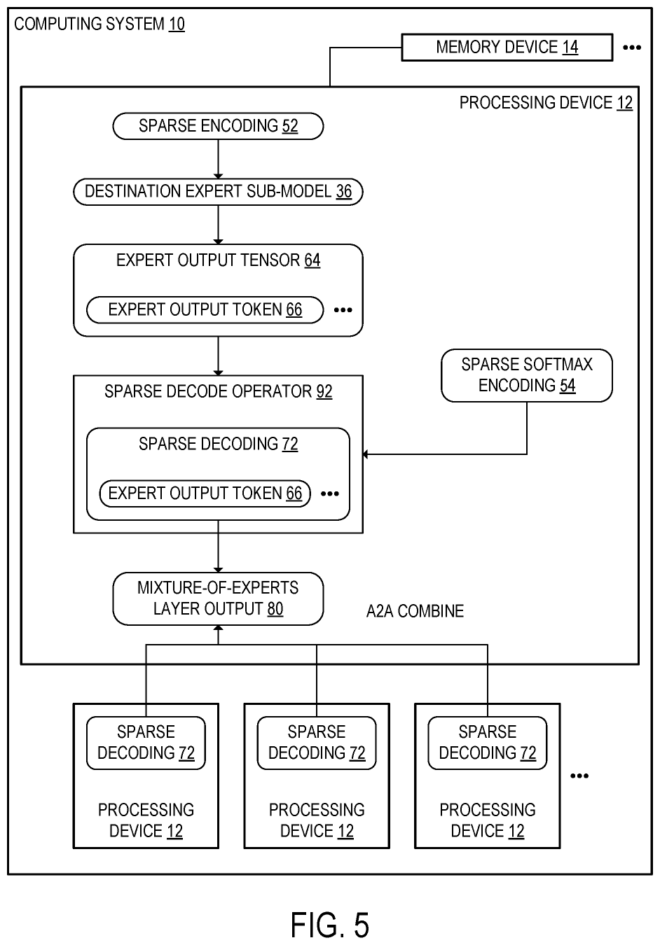

FIG. 5 schematically shows the computing system 10 when one or more destination expert sub-models 36 processes a copy of the sparse encoding 52. The plurality of processing devices 12 are configured to compute an expert output tensor 64 at the one or more destination expert sub-models 36. The expert output tensor 64, as shown in the example of FIG. 5, may include a plurality of expert output tokens 66. A corresponding expert output tensor 64 may be computed at each of the expert sub-models 34 that receives an input token 41. In examples in which the one or more destination expert sub-models 36 are parallelized across the plurality of processing devices 12, each of the processing devices 12 may be configured to compute a respective portion of the expert output tensor 64.

The plurality of processing devices 12 are further configured to each compute a respective sparse decoding 72 of the expert output tensor 64. In the example of FIG. 5, the sparse decoding 72 is computed at a sparse decode operator 92 that is configured to receive the expert output tensor 64 and the sparse SoftMax encoding 54 as input. The sparse decoding 72 may be computed using a portion of the expert output tensor 64 in examples in which different portions of the expert output tensor 64 are computed at different processing devices 12, as discussed above. The sparse decoding 72 may include the plurality of expert output tokens 66 computed at the destination expert sub-model 36.

The plurality of processing devices 12 are further configured to compute the MoE layer output 80 based at least in part on the sparse decoding 72 of the expert output tensor 64. The plurality of processing devices 12 may, as shown in FIG. 5, be configured to compute the MoE layer output 80 at least in part by combining respective sparse decodings 72 of a plurality of expert output tensors 64 across the plurality of processing devices 12 in an A2A combine operation. Thus, each of the processing devices 12 may receive a respective copy of the sparse decoding 72 computed at each of the other processing devices 12.

The plurality of processing devices 12 are further configured to convey the MoE layer output 80 to an additional computing process. For example, the MoE layer output 80 may be used as input into a subsequent layer of the MoE model 30. Additionally or alternatively, when the MoE layer output 80 is output of the MoE model 30 as a whole, the MoE layer output 80 may be output to a user (e.g., by sending the MoE layer output 80 to a client computing device 20, as shown in FIG. 1) or post-processed at some other computing process.

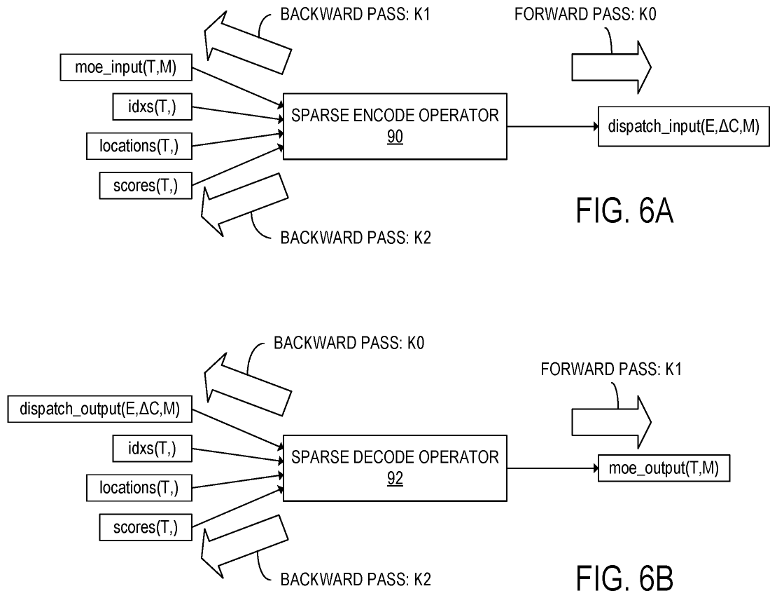

FIGS. 6A-6B schematically show examples of the sparse encode operator 90 and the sparse decode operator 92 in additional detail. Forward-pass and backward-pass computations at both the sparse encode operator 90 and the sparse decode operator 92 are shown in the example of FIGS. 6A-6B. As shown in FIGS. 6A-6B, the processing devices 12 are configured to execute kernels that receive input data on which the sparsifying transformations discussed above have been performed. Conventional kernels executed at GPUs or other hardware accelerators are typically unable to leverage input data sparsity to attain increases in processing efficiency. Although some existing hardware accelerators have kernels that achieve increased efficiency when processing inputs that exhibit fine-grained sparsity, such kernels do not support coarse-grained sparsity, which the sparse SoftMax encoding 54 exhibits. Accordingly, the kernels shown in FIGS. 6A-6B are provided in order to allow coarse-grained sparse inputs to be processed more efficiently at the plurality of processing devices 12.

At the sparse encode operator 90 depicted in FIG. 6A, the plurality of processing devices 12 are configured to compute the sparse encoding 52 during the forward pass at least in part by executing a first kernel K0. Via the first kernel K0, each processing device 12 of the plurality of processing devices 12 may be configured to compute a respective expert input tensor (shown in FIG. 6A as dispatch_input(E, ΔC, M)) as a product of the input tensor 40 (shown in FIG. 6A as moe_input(T, M)) and the sparse SoftMax encoding 54 (shown in FIG. 6A as scores(T,)) of the SoftMax output vector 48. T is the number of input tokens 41 received at each of the destination expert sub-models 36, and as discussed above, M is the channel size of each of the expert sub-models 34. In addition to moe_input(T, M) and scores (T,), the first kernel K0 is further configured to receive an expert identifier vector idxs(T,) and a location vector locations (T,) as input. The expert identifier vector idxs(T,) is a vector of indices of destination expert sub-models 36 to which the plurality of input tokens 41 included in the input tensor 40 are assigned. The location vector locations (T,) is a vector of locations of the input tokens 41 within the expert input tensor dispatch_input(E, ΔC, M).

The first kernel K0 may be configured to apply the following function:

Z[idxs[t]locations[t],M]=X[t,M]*Y[t]

In the above equation, Z is the output tensor of the first kernel K0, which corresponds to dispatch_input(E, ΔC, M) in the sparse encode operator 90 during the forward pass. X in the above equation corresponds to the input tensor 40, and Y corresponds to the sparse SoftMax encoding 54. t∈{1, . . . , T} are the indices of the input tokens 41 received at each of the destination expert sub-models 36. In this equation, X is a two-dimensional tensor, Y is a one-dimensional tensor, and Z is a three-dimensional tensor.

FIG. 6B schematically shows the sparse decode operator 92 at which the sparse decoding 72 may be computed. In the example of FIG. 6B, the plurality of processing devices 12 are further configured to compute the sparse decoding 72 at least in part by executing a second kernel K1. Via the second kernel K1 as shown in the example of FIG. 6B, each processing device 12 of the plurality of processing devices 12 is configured to compute a product of the expert output tensor 64 and the sparse SoftMax encoding 54 of the SoftMax output vector 48. The second kernel K1 may be configured to apply the following function:

X[t,M]=Z[idxs[t]locations[t],M]*Y[t]

In the above equation, X is the MoE layer output 80, which is indicated as moe_output(T, M) in FIG. 6B. Z is the expert output tensor 64, which is indicated as dispatch_output(E, ΔC, M), and Y is the sparse SoftMax encoding 54.

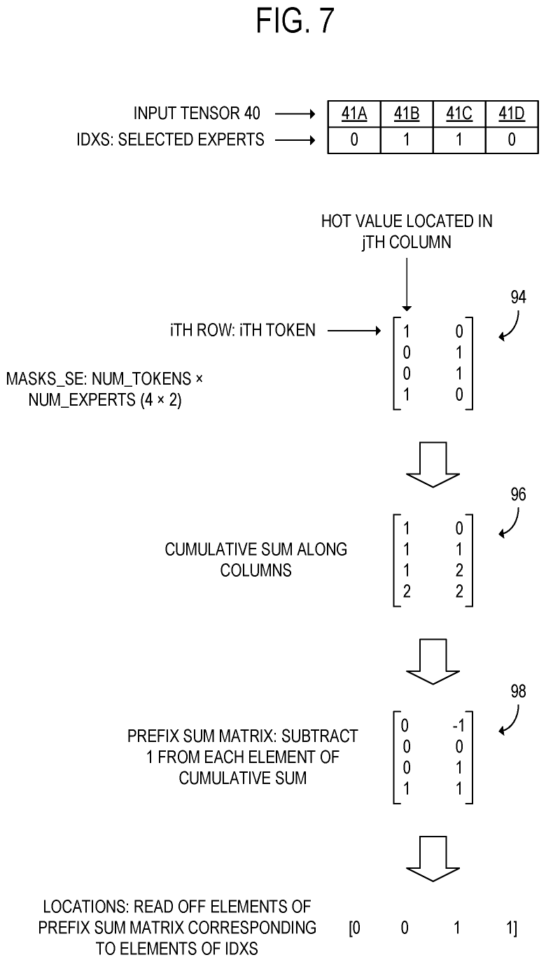

FIG. 7 schematically shows the computation of the location vector locations (T,), according to one example. In the example of FIG. 7, the input tensor 40 includes four input tokens 41A, 41B, 41C, and 41D. The MoE layer 32 in the example of FIG. 7 includes two expert sub-models 34, which are indexed as 0 and 1. The processing devices 12 are configured to compute the location vector locations(T,) based at least in part on the expert identifier vector idxs(T,). In this example, the expert identifier vector idxs(T,) indicates that the first input token 41A and the fourth input token 41B are assigned to expert 0 and that the second input token 41B and the third input token 41C are assigned to expert 1. The elements of the expert identifier vector idxs(T,) are respective indices of the expert sub-models 34 for which the input tokens 41 have the highest values in the sparse SoftMax encoding 54.

The plurality of processing devices 12 are configured to compute a mask matrix 94 (indicated as masks_se in FIG. 7) based at least in part on the expert identifier vector idxs(T,). In the example of FIG. 7, the number of rows included in the mask matrix 94 is equal to the number of input tokens 41, and the number of columns is equal to the number of expert sub-models 34. Each row of the mask matrix 94 is a one-hot vector associated with a particular input token 41. In the one-hot vector, the hot element is located in a column corresponding to the index of the destination expert sub-model 36 indicated for the input token 41 in the expert identifier vector idxs(T,).

The plurality of processing devices 12 are further configured to compute a cumulative sum matrix 96 from the mask matrix 94. Each element of the cumulative sum matrix 96 is equal to the cumulative sum of the elements of the same column of the mask matrix 94, up to and including the element at the same location in the mask matrix 94 as the element of the cumulative sum matrix being computed. The plurality of processing devices 12 are further configured to compute a prefix sum matrix 98 by subtracting 1 from each element of the cumulative sum matrix 96.

The plurality of processing devices 12 are further configured to compute the location vector locations (T,) as a vector of the elements of the prefix sum matrix 98 located at positions in each row of the prefix sum matrix 98 corresponding to the expert sub-model indices specified for the input tokens 41 in the expert identifier vector idxs(T,). Accordingly, in the example of FIG. 7, the plurality of processing devices 12 are configured to select the first element of the first row of the prefix sum matrix 98, the second element of the second row, the second element of the first row, and the first element of the fourth row for inclusion in the location vector locations (T,).

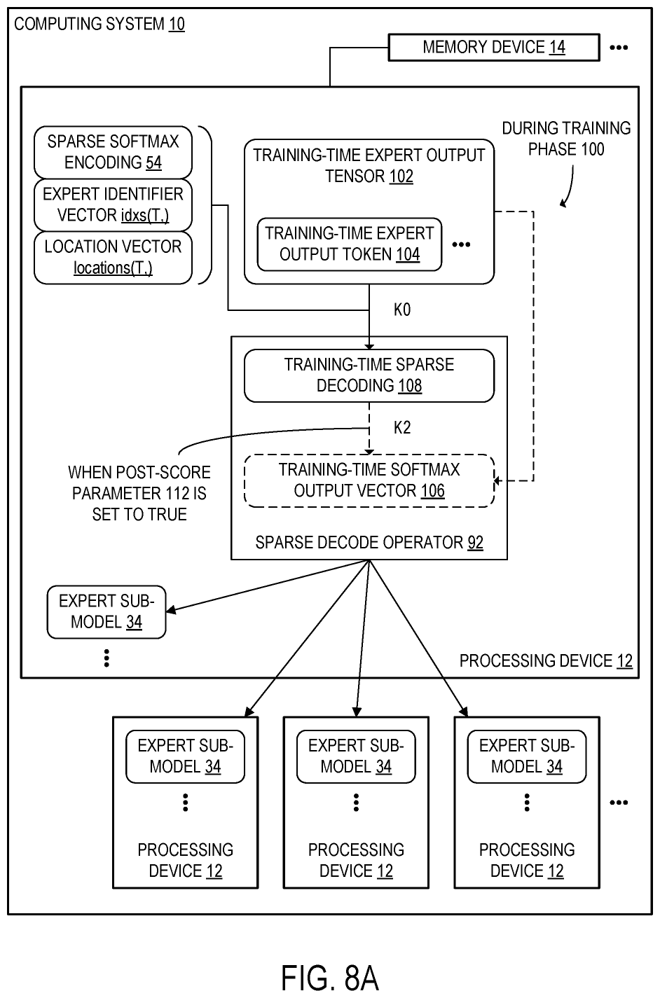

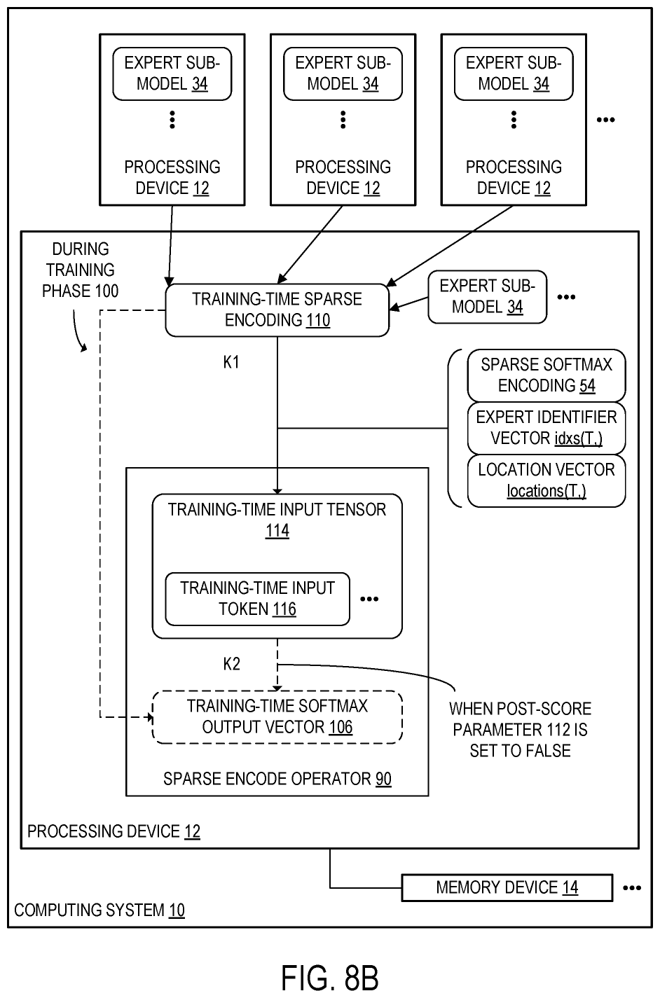

Returning to the example of FIGS. 6A-6B, the plurality of processing devices 12 are further configured to perform a backward pass through the MoE layer 32 during training of the MoE layer 32. The backward passes through the sparse encode operator 90 and the sparse decode operator 92 are depicted in FIGS. 6A-6B. In addition, FIGS. 8A-8B schematically show the computing system 10 during a training phase 100 in which the MoE layer 32 is trained.

FIG. 8A schematically shows the computing system 10 when the sparse decode operator 92 is executed during the backward pass. During the backward pass, the plurality of processing devices 12 may be further configured to compute a training-time sparse decoding 108 and a training-time SoftMax output vector 106 at the sparse decode operator 92. The training-time sparse decoding 108, which is indicated as dispatch_output(E, ΔC, M) in the example of FIG. 6B, may be computed based at least in part on a training-time output tensor 102 that includes a plurality of training-time expert output tokens 104. The plurality of processing devices 12 may be configured to compute the training-time sparse decoding 108 at least in part by executing the first kernel K0, as shown in the example of FIG. 6B. The sparse SoftMax encoding 54 may be reused from the forward pass as an input to the first kernel K0 during the backward pass. The expert identifier vector idxs(T,) and the location vector locations (T,) may also be reused from the forward pass.

As depicted in FIG. 6B, when the sparse decode operator 92 is executed during the backward pass, the plurality of processing devices 12 may be further configured to compute the training-time SoftMax output vector 106 at least in part by executing a third kernel K2. Via the third kernel K2, each processing device 12 of the plurality of processing devices 12 may be configured to compute a dot product of the training-time expert output tensor 102 and the training-time sparse decoding 108. The third kernel K2 may be configured to apply the following function:

Y[t]=dot(Z[idxs[t]locations[t], M], X[t,M])

In the sparse decode operator 92, X[t, M] corresponds to the training-time expert output tensor 102, which is labeled as moe_output(T, M) in FIG. 6B. Z[idxs[t]locations[t],M] corresponds to the training-time sparse decoding 108 in this example, which is labeled as dispatch_output(E, ΔC, M). Y [t] corresponds to the training-time SoftMax output vector 106, which is labeled as scores (T,).

During the backward pass, the plurality of processing devices 12 may be further configured to input the training-time sparse decoding 108 and the training-time SoftMax output vector 106 to one or more expert sub-models 34 of the plurality of expert sub-models 34. The training-time SoftMax output vector 106 may indicate which of the expert sub-models 34 are configured to process the training-time sparse decoding 108. The training-time sparse decoding 108 may be transmitted to those expert sub-models 34 in an A2A dispatch operation.

Alternatively to computing the training-time SoftMax output vector 106 at the sparse decode operator, the plurality of processing devices 12 may instead be configured to compute the training-time SoftMax output vector 106 at the sparse encode operator 90 subsequently to computing gradients at the one or more expert sub-models 34, as depicted in FIG. 8B. A post-score parameter 112 may be used to specify whether the training-time SoftMax output vector 106 is computed at the sparse decode operator 92 or the sparse encode operator 90. When the post-score parameter 112 is set to true, as shown in the example of FIG. 8A, the plurality of processing devices 12 may be configured to compute the training-time SoftMax output vector 106 at the sparse decode operator 92 as the dot product of the training-time expert output tensor 102 and the training-time sparse decoding 108. The post-score parameter 112 may, for example, be a user-defined parameter.

FIG. 8B schematically shows the computing system 10 when the sparse encode operator 90 is executed during the backward pass. At the sparse encode operator 90, the plurality of processing devices 12 are further configured to compute a training-time input tensor 114. The training-time input tensor 114 may be computed based at least in part on a training-time sparse encoding 110 received from one or more expert sub-models 34 of the plurality of expert sub-models 34. The training-time sparse encoding 110 may be received from the one or more expert sub-models 34 via an A2A combine operation. When the plurality of processing devices 12 generate the training-time input tensor 114, the plurality of processing devices 12 may be configured to execute the second kernel K1. In such examples, as shown in FIG. 6A, the training-time sparse encoding 110 (labeled as dispatch_input(E, ΔC, M) in the example of FIG. 6A) may be utilized as input to the second kernel K1 when the training-time input tensor 114 is computed. The training-time input tensor 114 is indicated as moe_input(T, M) in FIG. 6A and may include a plurality of training-time input tokens 116. The sparse SoftMax encoding 54, the expert identifier vector idxs(T,), and the location vector locations (T,) may be reused from the forward pass as inputs to the second kernel K1.

In the example of FIG. 8B, the post-score parameter 112 is set to false. In this example, the plurality of processing devices 12 may be further configured to compute the training-time SoftMax output vector 106 at the sparse encode operator 90 at least in part by executing the third kernel K2. The inputs to the third kernel K2 in the backward pass, according to the example of FIG. 6A, are the training-time input tensor 114 and the training-time sparse encoding 110. Accordingly, the plurality of processing devices 12 may be configured to generate the training-time input tensor 114 and the training-time SoftMax output vector 106 as the outputs of the backward pass.

In examples in which the processing devices execute the kernels discussed above, the processing devices 12 may utilize processing speedups that would otherwise only be applicable to dense computation. For example, the plurality of processing devices 12 may be configured to perform warp shuffling, the Blelloch scan algorithm, and/or element vectorization for low-precision computation. Accordingly, training and inferencing at the MoE layer 32 may be performed more efficiently.

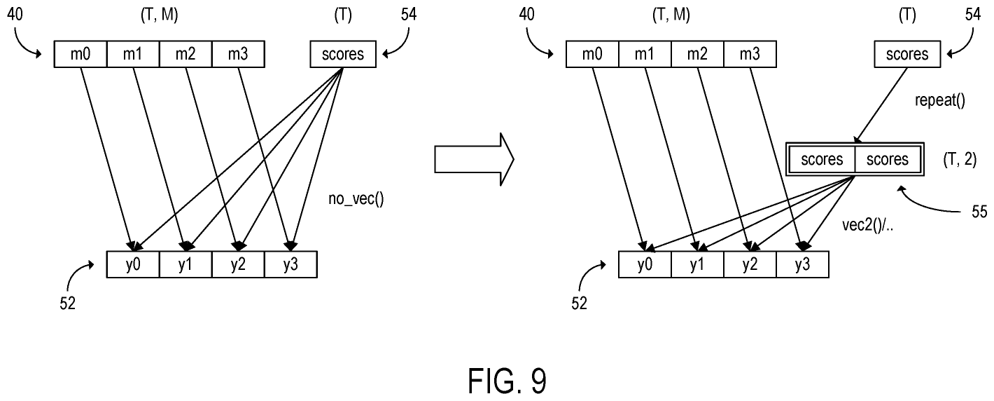

FIG. 9 shows an additional transformation that may be performed at the plurality of processing devices 12 in some examples when the sparse encoding 52 is generated. In the example of FIG. 9, the plurality of processing devices 12 may be further configured to duplicate the sparse SoftMax encoding 54 (shown as scores in FIG. 9). Thus, the processing devices 12 are configured to transform the sparse SoftMax encoding 54 from a vector with size (T) into a transformed sparse SoftMax encoding 55 structured as a two-dimensional tensor with size (T, 2). Accordingly, when the plurality of processing devices 12 natively support width-2 tensors as a data type, the sparse SoftMax encoding 54 may be transformed to allow for more efficient processing of the sparse SoftMax encoding 54. In other examples, the plurality of processing devices 12 may instead be configured to quadruple the sparse SoftMax encoding 54 to generate a transformed sparse SoftMax encoding 55 structured as a two-dimensional tensor with size (T, 4).

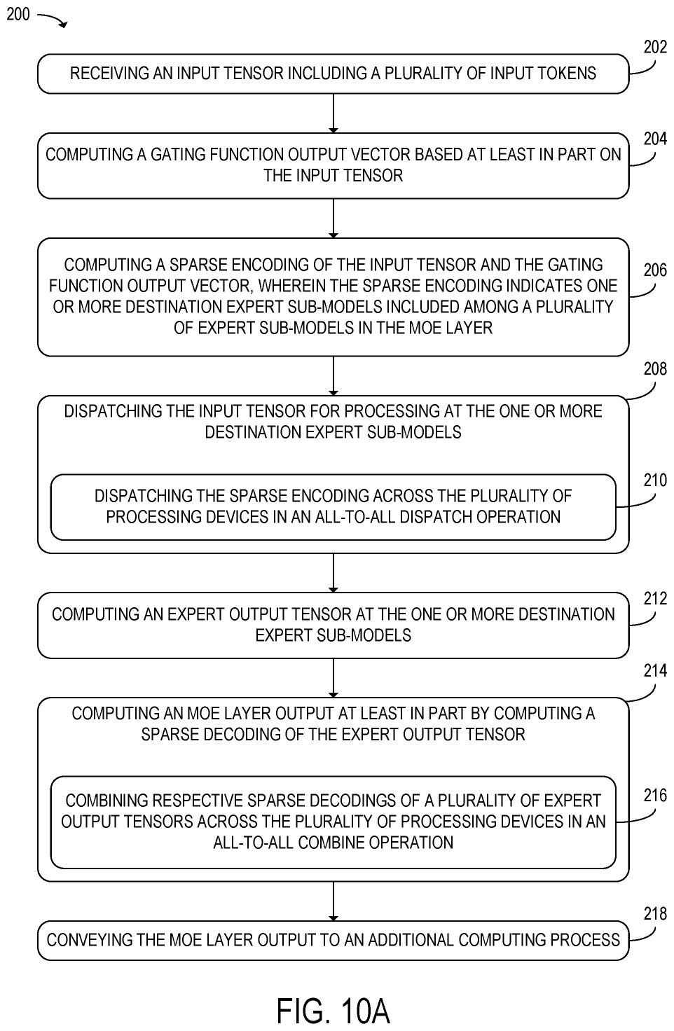

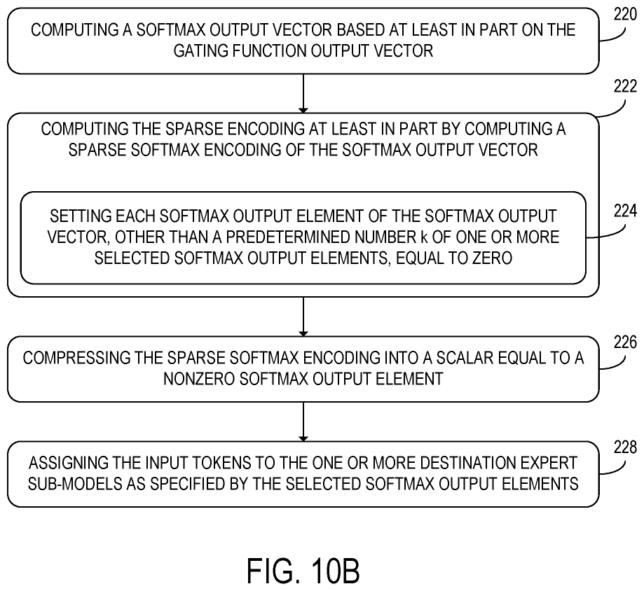

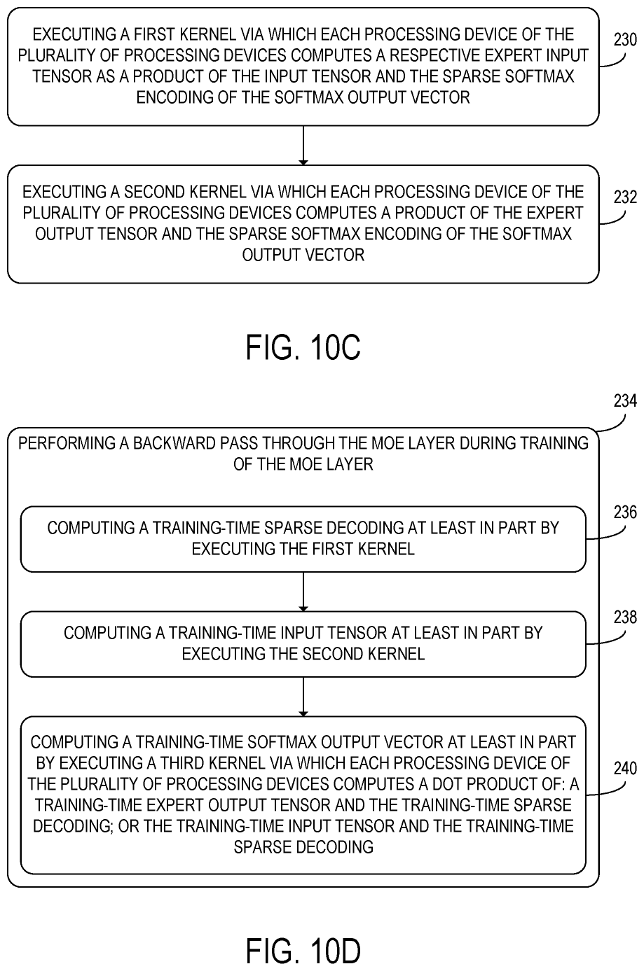

FIG. 10A shows a flowchart of a method 200 for use with a computing system to execute an MoE layer included in an MoE model. The method 200 is performed at a plurality of processing devices, which may include one or more CPUs, one or more GPUs, and/or one or more other hardware accelerators. At step 202, the method 200 includes receiving an input tensor including a plurality of input tokens. The input tensor may be received as an initial input to the MoE model (e.g., when the MoE layer is the first layer in the MoE model) or may be received from another layer of the MoE model. For example, the MoE model may alternate between MoE layers and linear layers.

At step 204, the method 200 further includes computing a gating function output vector based at least in part on the input tensor. The gating function output vector may be used to determine the routing of the input tokens to corresponding expert sub-models included in the MoE layer. The gating function at which the gating function output vector is computed may include a plurality of learnable parameters that are trained during training of the MoE layer.

At step 206, the method 200 further includes computing a sparse encoding of the input tensor and the gating function output vector. The sparse encoding indicates one or more destination expert sub-models included among a plurality of expert sub-models in the MoE layer. In the sparse encoding, respective destination expert sub-models may be indicated for the input tokens included in the input tensor.

At step 208, the method 200 further includes dispatching the input tensor for processing at the one or more destination expert sub-models. Step 208 may include, at step 210, dispatching the sparse encoding across the plurality of processing devices in an all-to-all dispatch operation.

At step 212, the method 200 further includes computing an expert output tensor at the one or more destination expert sub-models. Each output tensor that receives one or more of the input tokens included in the sparse encoding may compute a corresponding expert output tensor. The expert output tensor may include a plurality of expert output tokens.

At step 214, the method 200 further includes computing an MoE layer output at least in part by computing a sparse decoding of the expert output tensor. Computing the MoE layer output at step 214 may include, at step 216, combining respective sparse decodings of a plurality of expert output tensors across the plurality of processing devices in an all-to-all combine operation.

At step 218, the method 200 further includes conveying the MoE layer output to an additional computing process. For example, the additional computing process may be another layer of the MoE model. In examples in which the MoE layer output is an overall output of the MoE model, the additional computing process may be a computing process that stores the MoE layer output in memory, applies post-processing computations to the output of the MoE layer, transmits the MoE layer output to a client computing device, or presents the MoE layer output to a user.

FIG. 10B shows additional steps of the method 200 that may be performed when the sparse encoding is computed at step 206. At step 220, generating the sparse encoding at step 206 may include computing a SoftMax output vector based at least in part on the gating function output vector. The SoftMax output vector is computed in such examples by applying a SoftMax function to the gating function output vector.

At step 222, step 206 may further include computing the sparse encoding at least in part by computing a sparse SoftMax encoding of the SoftMax output vector. Computing the sparse SoftMax encoding may include, at step 224, setting each SoftMax output element of the SoftMax output vector, other than a predetermined number k of one or more selected SoftMax output elements, equal to zero. Accordingly, SoftMax output elements that are close to zero may be rounded down to sparsify the SoftMax output vector. The predetermined number k may be equal to the number of the one or more destination expert sub-models. In addition, the predetermined number k of the SoftMax output elements may be the top-k largest SoftMax output elements among the plurality of SoftMax output elements included in the SoftMax output vector. Accordingly, when the sparse SoftMax encoding is computed, the elements other than the top k largest elements may be set to zero. The top k largest elements may each be set to one in some examples.

At step 226, in examples in which the predetermined number k is equal to one, generating the sparse encoding at step 206 may further include compressing the sparse SoftMax encoding into a scalar equal to the nonzero SoftMax output element subsequently to setting each of the plurality of SoftMax output elements other than one SoftMax output element to zero. Thus, in examples in which the sparse SoftMax encoding is a one-hot vector, the sparse SoftMax encoding may be further sparsified.

At step 228, step 206 may further include assigning the input tokens to the one or more destination expert sub-models as specified by the selected SoftMax output elements. The indices of the one or more nonzero elements of the sparse SoftMax encoding may indicate the one or more destination expert sub-models. In examples in which step 226 is performed, the input tokens may be assigned to the destination expert sub-model prior to further sparsifying the sparse SoftMax encoding into a scalar.

FIG. 10C shows additional steps of the method 200 of FIG. 10A that may be performed when the sparse encoding and the sparse decoding are computed. At step 230, computing the sparse encoding at step 206 may include executing a first kernel. Via the first kernel, each processing device of the plurality of processing devices may compute a respective expert input tensor as a product of the input tensor and the sparse SoftMax encoding of the SoftMax output vector. An expert identifier vector and a location vector may also be used as input to the first kernel. The expert identifier vector in such examples may be a vector of indices of destination expert sub-models to which the input tokens are assigned. The location vector may be a vector of locations of the input tokens within the expert input tensor.

At step 232, computing the sparse decoding at step 214 may include executing a second kernel. Via the second kernel, each processing device of the plurality of processing devices may compute a product of the expert output tensor and the sparse SoftMax encoding of the SoftMax output vector. The second kernel may also receive the expert identifier vector and the location vector as input. The first kernel and the second kernel may be CPU kernels, GPU kernels, or kernels of some other hardware accelerator.

FIG. 10D shows additional steps of the method 200 that may be performed when training the MoE layer in examples in which the steps of FIG. 10C are performed. At step 234, the method 200 may include performing a backward pass through the MoE layer during training of the MoE layer. Step 234 may be performed in a training phase that occurs prior to an inferencing phase. At step 236, performing the backward pass at step 234 may include computing a training-time sparse decoding and a first training-time SoftMax output vector at least in part by executing the first kernel. The first kernel may receive a training-time expert output tensor as input. In addition, at step 238, step 234 may further include computing a training-time input tensor at least in part by executing the second kernel. The second kernel may receive a training-time sparse encoding as input. The SoftMax output encoding, the expert identifier vector, and the location vector may also be reused from the forward pass as inputs to the first kernel and the second kernel at steps 236 and 238.

At step 240, step 234 may further include computing a training-time SoftMax output vector at least in part by executing a third kernel. Via the third kernel, each processing device of the plurality of processing devices may compute a dot product of the training-time expert output tensor and the training-time sparse decoding. In such examples, the third kernel may be executed at the sparse decode operator. Alternatively, each processing device of the plurality of processing devices may compute a dot product of the training-time input tensor and the training-time sparse decoding. In such examples, the third kernel may be executed at the sparse encode operator. The user may set a post-score parameter to specify whether the training-time SoftMax output vector is computed at the sparse decode operator or the sparse encode operator.

Using the systems and methods discussed above, the amount of memory used by the processing devices when executing the MoE layer may be reduced. The following table compares the amounts of memory used to execute the MoE layer for the approach discussed above (TUTEL) and a conventional MoE mode (Fairseq). In the following table, M=V=4096, k=2, and ΔE=2, where V is a feed-forward hidden layer size and ΔE is a number of local expert sub-models executed in parallel at each GPU.

| Tokens/step | Fairseq MoE (GiB) | TUTEL MoE (GiB) | |
|---|---|---|---|
| 4096 | 3.7 | 2.9 | (−21.6%) |
| 8192 | 6.2 | 3.2 | (−48.4%) |
| 16384 | 16.3 | 4.0 | (−75.5%) |
| 32768 | 57.9 | 5.7 | (90.2%) |

As shown in the above table, the amount of memory used by the TUTEL MoE layer scales to large numbers of tokens per step significantly more efficiently than a conventional MoE layer.

In addition to saving memory, the techniques discussed above may reduce the latency of executing the MoE layer. These latency savings occur during the A2A dispatch stage and the A2A combine stage. The latency of these stages may be reduced durations much smaller than that of the expert computation stage. In contrast, at prior MoE layers, the latency of the A2A dispatch stage and the A2A combine stage frequently account for the majority of the execution time of the MoE layer. Thus, the systems and methods discussed above may allow for significantly faster training and inferencing at the MoE layer.

In some embodiments, the methods and processes described herein may be tied to a computing system of one or more computing devices. In particular, such methods and processes may be implemented as a computer-application program or service, an application-programming interface (API), a library, and/or other computer-program product.

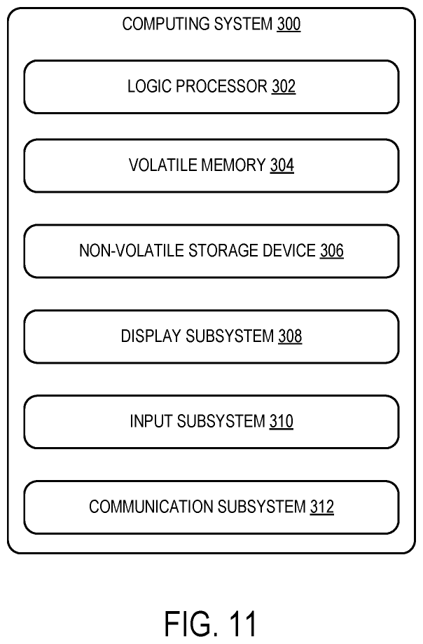

FIG. 11 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be instantiated in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 11.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including a plurality of processing devices configured to execute a Mixture-of-Experts (MoE) layer included in an MoE model at least in part by receiving an input tensor including a plurality of input tokens. Executing the MoE layer further includes computing a gating function output vector based at least in part on the input tensor. Executing the MoE layer further includes computing a sparse encoding of the input tensor and the gating function output vector. The sparse encoding indicates one or more destination expert sub-models included among a plurality of expert sub-models in the MoE layer. Executing the MoE layer further includes dispatching the input tensor for processing at the one or more destination expert sub-models. Executing the MoE layer further includes computing an expert output tensor at the one or more destination expert sub-models. Executing the MoE layer further includes computing an MoE layer output at least in part by computing a sparse decoding of the expert output tensor. Executing the MoE layer further includes conveying the MoE layer output to an additional computing process. The above features may have the technical effect of reducing the latency and memory usage of the MoE layer by performing sparse computations at the MoE layer.

According to this aspect, the plurality of processing devices may be further configured to compute a SoftMax output vector based at least in part on the gating function output vector. The plurality of processing devices may be further configured to compute the sparse encoding at least in part by computing a sparse SoftMax encoding of the SoftMax output vector. The above features may have the technical effect of increasing the efficiency of operations performed on the SoftMax output vector by sparsifying the SoftMax output vector.

According to this aspect, the plurality of processing devices may be configured to compute the sparse SoftMax encoding at least in part by setting each SoftMax output element of the SoftMax output vector, other than a predetermined number k of one or more selected SoftMax output elements, equal to zero. The above features may have the technical effect of increasing the efficiency of operations performed on the SoftMax output vector by sparsifying the SoftMax output vector.

According to this aspect, the plurality of processing devices may be configured to assign the input tokens to the one or more destination expert sub-models as specified by the selected SoftMax output elements. The predetermined number k may be equal to a number of the one or more destination expert sub-models. The above features may have the technical effect of routing the input tokens to the destination expert sub-models.

According to this aspect, the predetermined number k of the SoftMax output elements may be the top-k largest SoftMax output elements among the plurality of SoftMax output elements. The above feature may have the technical effect of compressing the SoftMax output vector in a manner that preserves information relevant to destination expert sub-model selection.

According to this aspect, the predetermined number k may be equal to one. Subsequently to setting each of the plurality of SoftMax output elements other than one SoftMax output element to zero, the plurality of processing devices may be further configured to compress the sparse SoftMax encoding into a scalar equal to the nonzero SoftMax output element. The above features may have the technical effect of further compressing the sparse SoftMax encoding.

According to this aspect, the plurality of processing devices may be further configured to dispatch the sparse encoding across the plurality of processing devices in an all-to-all dispatch operation. The plurality of processing devices may be further configured to compute the MoE layer output at least in part by combining respective sparse decodings of a plurality of expert output tensors across the plurality of processing devices in an all-to-all combine operation. The above features may have the technical effect of distributing the expert computation across the plurality of processing devices.

According to this aspect, the plurality of processing devices may be configured to compute the sparse encoding at least in part by executing a first kernel via which each processing device of the plurality of processing devices is configured to compute a respective expert input tensor as a product of the input tensor and the sparse SoftMax encoding of the SoftMax output vector. The above features may have the technical effect of efficiently computing the sparse encoding.

According to this aspect, the plurality of processing devices may be further configured to compute the sparse decoding at least in part by executing a second kernel via which each processing device of the plurality of processing devices is configured to compute a product of the expert output tensor and the sparse SoftMax encoding of the SoftMax output vector. The above features may have the technical effect of efficiently computing the sparse decoding.

According to this aspect, the plurality of processing devices may be further configured to perform a backward pass through the MoE layer during training of the MoE layer. During the backward pass, the plurality of processing devices may be further configured to compute a training-time sparse decoding at least in part by executing the first kernel and compute a training-time input tensor at least in part by executing the second kernel. During the backward pass, the plurality of processing devices may be further configured to compute a training-time SoftMax output vector at least in part by executing a third kernel. via the third kernel, each processing device of the plurality of processing devices is configured to compute a dot product of a training-time expert output tensor and the training-time sparse decoding or the training-time input tensor and the training-time sparse decoding. The above features may have the technical effect of efficiently performing the backward pass through the MoE layer.

According to this aspect, the plurality of processing devices may be further configured to compute a doubled gating function output tensor including two copies of the gating function output vector. The plurality of processing devices may be further configured to compute the sparse encoding based at least in part on the doubled gating function output vector. The above features may have the technical effect of allowing native data types of the processing devices to be used when computing the sparse encoding.

According to another aspect of the present disclosure, a method for use with a computing system to execute a Mixture-of-Experts (MoE) layer included in an MoE model is provided. The method includes receiving an input tensor including a plurality of input tokens. The method further includes computing a gating function output vector based at least in part on the input tensor. The method further includes computing a sparse encoding of the input tensor and the gating function output vector. The sparse encoding indicates one or more destination expert sub-models included among a plurality of expert sub-models in the MoE layer. The method further includes dispatching the input tensor for processing at the one or more destination expert sub-models. The method further includes computing an expert output tensor at the one or more destination expert sub-models. The method further includes computing an MoE layer output at least in part by computing a sparse decoding of the expert output tensor. The method further includes conveying the MoE layer output to an additional computing process. The above features may have the technical effect of reducing the latency and memory usage of the MoE layer by performing sparse computations at the MoE layer.

According to this aspect, the method may further include computing a SoftMax output vector based at least in part on the gating function output vector. The method may further include computing the sparse encoding at least in part by computing a sparse SoftMax encoding of the SoftMax output vector. The above features may have the technical effect of increasing the efficiency of operations performed on the SoftMax output vector by sparsifying the SoftMax output vector.

According to this aspect, the method may further include computing the sparse SoftMax encoding at least in part by setting each SoftMax output element of the SoftMax output vector, other than a predetermined number k of one or more selected SoftMax output elements, equal to zero. The above features may have the technical effect of increasing the efficiency of operations performed on the SoftMax output vector by sparsifying the SoftMax output vector.

According to this aspect, the method may further include assigning the input tokens to the one or more destination expert sub-models as specified by the selected SoftMax output elements. The predetermined number k may be equal to a number of the one or more destination expert sub-models. The predetermined number k of the SoftMax output elements may be the top-k largest SoftMax output elements among the plurality of SoftMax output elements. The above feature may have the technical effect of compressing the SoftMax output vector in a manner that preserves information relevant to destination expert sub-model selection.

According to this aspect, the predetermined number k may be equal to one. Subsequently to setting each of the plurality of SoftMax output elements other than one SoftMax output element to zero, the method may further include compressing the sparse SoftMax encoding into a scalar equal to the nonzero SoftMax output element. The above features may have the technical effect of further compressing the sparse SoftMax encoding.

According to this aspect, the method may further include dispatching the sparse encoding across the plurality of processing devices in an all-to-all dispatch operation. The method may further include computing the MoE layer output at least in part by combining respective sparse decodings of a plurality of expert output tensors across the plurality of processing devices in an all-to-all combine operation. The above features may have the technical effect of distributing the expert computation across the plurality of processing devices.

According to this aspect, the method may further include computing the sparse encoding at least in part by executing a first kernel via which each processing device of the plurality of processing devices computes a respective expert input tensor as a product of the input tensor and the sparse SoftMax encoding of the SoftMax output vector. The method may further include computing the sparse decoding at least in part by executing a second kernel via which each processing device of the plurality of processing devices computes a product of the expert output tensor and the sparse SoftMax encoding of the SoftMax output vector. The above features may have the technical effect of efficiently computing the sparse encoding and the sparse decoding.

According to this aspect, the method may further include performing a backward pass through the MoE layer during training of the MoE layer. The backward pass may include computing a training-time sparse decoding at least in part by executing the first kernel and computing a training-time input tensor at least in part by executing the second kernel. The backward pass may further include computing a training-time SoftMax output vector at least in part by executing a third kernel via which each processing device of the plurality of processing devices computes a dot product of a training-time expert output tensor and the training-time sparse decoding or the training-time input tensor and the training-time sparse decoding. The above features may have the technical effect of efficiently performing the backward pass through the MoE layer.

According to another aspect of the present disclosure, a computing system is provided, including a plurality of processing devices configured to execute a Mixture-of-Experts (MoE) layer included in an MoE model. Executing the MoE layer includes receiving an input tensor including a plurality of input tokens. Executing the MoE layer further includes computing a gating function output vector based at least in part on the input tensor. Executing the MoE layer further includes computing a sparse encoding of the input tensor and the gating function output vector. The sparse encoding indicates one or more destination expert sub-models included among a plurality of expert sub-models in the MoE layer. Computing the sparse encoding includes computing a SoftMax output vector based at least in part on the gating function output vector. Computing the sparse encoding further includes computing a sparse SoftMax encoding of the SoftMax output vector. Computing the sparse encoding further includes executing a first kernel via which each processing device of the plurality of processing devices is configured to compute a respective expert input tensor as a product of the input tensor and the sparse SoftMax encoding of the SoftMax output vector. Executing the MoE layer further includes dispatching the input tensor for processing at the one or more destination expert sub-models. Executing the MoE layer further includes computing an expert output tensor at the one or more destination expert sub-models. Executing the MoE layer further includes computing an MoE layer output at least in part by computing a sparse decoding of the expert output tensor. Computing the sparse decoding further includes executing a second kernel via which each processing device of the plurality of processing devices is configured to compute a product of the expert output tensor and the sparse SoftMax encoding of the SoftMax output vector. Executing the MoE layer further includes conveying the MoE layer output to an additional computing process. The above features may have the technical effect of reducing the latency and memory usage of the MoE layer by performing sparse computations at the MoE layer.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
a plurality of processing devices configured to execute a Mixture-of-Experts (MoE) layer included in an MoE model at least in part by:
receiving an input tensor including a plurality of input tokens;
computing a gating function output vector based at least in part on the input tensor;
computing a sparse encoding of the input tensor and the gating function output vector, wherein the sparse encoding indicates one or more destination expert sub-models included among a plurality of expert sub-models in the MoE layer;
dispatching the input tensor for processing at the one or more destination expert sub-models;
computing an expert output tensor at the one or more destination expert sub-models;
computing an MoE layer output at least in part by computing a sparse decoding of the expert output tensor; and
conveying the MoE layer output to an additional computing process.

2. The computing system of claim 1, wherein the plurality of processing devices are further configured to:
compute a SoftMax output vector based at least in part on the gating function output vector; and
compute the sparse encoding at least in part by computing a sparse SoftMax encoding of the SoftMax output vector.

3. The computing system of claim 2, wherein the plurality of processing devices are configured to compute the sparse SoftMax encoding at least in part by setting each SoftMax output element of the SoftMax output vector, other than a predetermined number k of one or more selected SoftMax output elements, equal to zero.

4. The computing system of claim 3, wherein:
the plurality of processing devices are configured to assign the input tokens to the one or more destination expert sub-models as specified by the selected SoftMax output elements; and
the predetermined number k is equal to a number of the one or more destination expert sub-models.

5. The computing system of claim 3, wherein the predetermined number k of the SoftMax output elements are the top-k largest SoftMax output elements among the plurality of SoftMax output elements.

6. The computing system of claim 3, wherein:
the predetermined number k is equal to one; and
subsequently to setting each of the plurality of SoftMax output elements other than one SoftMax output element to zero, the plurality of processing devices are further configured to compress the sparse SoftMax encoding into a scalar equal to the nonzero SoftMax output element.

7. The computing system of claim 3, wherein the plurality of processing devices are further configured to:
dispatch the sparse encoding across the plurality of processing devices in an all-to-all dispatch operation; and
compute the MoE layer output at least in part by combining respective sparse decodings of a plurality of expert output tensors across the plurality of processing devices in an all-to-all combine operation.

8. The computing system of claim 7, wherein the plurality of processing devices are configured to compute the sparse encoding at least in part by executing a first kernel via which each processing device of the plurality of processing devices is configured to compute a respective expert input tensor as a product of the input tensor and the sparse SoftMax encoding of the SoftMax output vector.

9. The computing system of claim 8, wherein the plurality of processing devices are further configured to compute the sparse decoding at least in part by executing a second kernel via which each processing device of the plurality of processing devices is configured to compute a product of the expert output tensor and the sparse SoftMax encoding of the SoftMax output vector.

10. The computing system of claim 9, wherein:
the plurality of processing devices are further configured to perform a backward pass through the MoE layer during training of the MoE layer; and
during the backward pass, the plurality of processing devices are further configured to:
compute a training-time sparse decoding at least in part by executing the first kernel;
compute a training-time input tensor at least in part by executing the second kernel; and
compute a training-time SoftMax output vector at least in part by executing a third kernel, wherein, via the third kernel, each processing device of the plurality of processing devices is configured to compute a dot product of:
a training-time expert output tensor and the training-time sparse decoding; or
the training-time input tensor and the training-time sparse decoding.

11. The computing system of claim 1, wherein the plurality of processing devices are further configured to:
compute a doubled gating function output tensor including two copies of the gating function output vector; and
compute the sparse encoding based at least in part on the doubled gating function output vector.

12. A method for use with a computing system to execute a Mixture-of-Experts (MoE) layer included in an MoE model, the method comprising:
receiving an input tensor including a plurality of input tokens;
computing a gating function output vector based at least in part on the input tensor;
computing a sparse encoding of the input tensor and the gating function output vector, wherein the sparse encoding indicates one or more destination expert sub-models included among a plurality of expert sub-models in the MoE layer;
dispatching the input tensor for processing at the one or more destination expert sub-models;
computing an expert output tensor at the one or more destination expert sub-models;
computing an MoE layer output at least in part by computing a sparse decoding of the expert output tensor; and
conveying the MoE layer output to an additional computing process.

13. The method of claim 12, further comprising:
computing a SoftMax output vector based at least in part on the gating function output vector; and
computing the sparse encoding at least in part by computing a sparse SoftMax encoding of the SoftMax output vector.

14. The method of claim 13, further comprising computing the sparse SoftMax encoding at least in part by setting each SoftMax output element of the SoftMax output vector, other than a predetermined number k of one or more selected SoftMax output elements, equal to zero.

15. The method of claim 14, further comprising assigning the input tokens to the one or more destination expert sub-models as specified by the selected SoftMax output elements, wherein:
the predetermined number k is equal to a number of the one or more destination expert sub-models; and
the predetermined number k of the SoftMax output elements are the top-k largest SoftMax output elements among the plurality of SoftMax output elements.

16. The method of claim 14, wherein:
the predetermined number k is equal to one; and
subsequently to setting each of the plurality of SoftMax output elements other than one SoftMax output element to zero, the method further comprises compressing the sparse SoftMax encoding into a scalar equal to the nonzero SoftMax output element.

17. The method of claim 14, further comprising:
dispatching the sparse encoding across the plurality of processing devices in an all-to-all dispatch operation; and
computing the MoE layer output at least in part by combining respective sparse decodings of a plurality of expert output tensors across the plurality of processing devices in an all-to-all combine operation.

18. The method of claim 17, further comprising:
computing the sparse encoding at least in part by executing a first kernel via which each processing device of the plurality of processing devices computes a respective expert input tensor as a product of the input tensor and the sparse SoftMax encoding of the SoftMax output vector; and
computing the sparse decoding at least in part by executing a second kernel via which each processing device of the plurality of processing devices computes a product of the expert output tensor and the sparse SoftMax encoding of the SoftMax output vector.

19. The method of claim 18, further comprising performing a backward pass through the MoE layer during training of the MoE layer, wherein the backward pass includes:
computing a training-time sparse decoding at least in part by executing the first kernel;
computing a training-time input tensor at least in part by executing the second kernel; and
computing a training-time SoftMax output vector at least in part by executing a third kernel via which each processing device of the plurality of processing devices computes a dot product of:
a training-time expert output tensor and the training-time sparse decoding; or
the training-time input tensor and the training-time sparse decoding.

20. A computing system comprising:
a plurality of processing devices configured to execute a Mixture-of-Experts (MoE) layer included in an MoE model at least in part by:
receiving an input tensor including a plurality of input tokens;
computing a gating function output vector based at least in part on the input tensor;
computing a sparse encoding of the input tensor and the gating function output vector, wherein:
the sparse encoding indicates one or more destination expert sub-models included among a plurality of expert sub-models in the MoE layer; and
computing the sparse encoding includes:
computing a SoftMax output vector based at least in part on the gating function output vector;
computing a sparse SoftMax encoding of the SoftMax output vector; and
executing a first kernel via which each processing device of the plurality of processing devices is configured to compute a respective expert input tensor as a product of the input tensor and the sparse SoftMax encoding of the SoftMax output vector;
dispatching the input tensor for processing at the one or more destination expert sub-models;
computing an expert output tensor at the one or more destination expert sub-models;
computing an MoE layer output at least in part by computing a sparse decoding of the expert output tensor, wherein computing the sparse decoding includes executing a second kernel via which each processing device of the plurality of processing devices is configured to compute a product of the expert output tensor and the sparse SoftMax encoding of the SoftMax output vector; and
conveying the MoE layer output to an additional computing process.
